(19) United States
(12) Patent Application Publication
(10) Pub. No.: US 2023/0396387 A1
(43) Pub. Date: Dec. 7, 2023

(54) Concept for Flexible SRS Bandwidth Adaptation

(71) Applicant: Telefonaktiebolaget LM Ericsson (PUBL), Stockholm (SE)

(72) Inventors: Robert Mark Harrison, GRAPEVINE, TX (US); Mattias Frenne, UPPSALA (SE); Andreas Nilsson, GÖTEBORG (SE); Xinlin Zhang, GÖTEBORG (SE); Fredrik Athley, Västra Frölunda (SE); Sven Jacobsson, VÄSTRA FRÖLUNDA (SE); Eleftherios Karipidis, STOCKHOLM (SE)

(21) Appl. No.: 18/032,928

(22) PCT Filed: Oct. 22, 2021
(86) PCT No.: PCT/IB2021/059779

§ 371 Date: Apr. 20, 2023

Related U.S. Application Data
(60) Provisional application No. 63/105,005, filed on Oct. 23, 2020.

(51) Int. Cl. H04L 5/00

(52) U.S. Cl. CPC H04L 5/0051; H04L 5/0094

(57) ABSTRACT

According to certain embodiments, a method performed by a wireless device comprises determining a configuration for sounding reference signal (SRS) transmission. The configuration is determined at least in part based on information received from a network node. The method further comprises performing the SRS transmission according to the configuration.

### TECHNICAL FIELD

Certain embodiments of the present disclosure relate, in general, to wireless networks and, more particularly, to flexible sounding reference signal (SRS) bandwidth adaptation.

### BACKGROUND

The SRS is used in third generation partnership project (3GPP) systems, such as Long Term Evolution (LTE) systems and New Radio (NR) systems, to estimate the channel in the uplink (UL). The application for the SRS is mainly to provide a reference signal to evaluate the channel quality in order to, e.g., derive the appropriate transmission/reception beams or to perform link adaptation (i.e., setting the rank, the modulation and coding scheme (MCS), and the multiple-input multiple-output (MIMO) precoder) for physical uplink shared channel (PUSCH) transmission. The signal is functionality-wise similar to the downlink (DL) channel state information reference signal (CSI-RS), which provides similar beam management and link adaptation functions in the DL. SRS can be used instead of (or in combination with) CSI-RS to acquire DL channel state information (CSI) (by means of uplink-downlink channel reciprocity) for enabling physical downlink shared channel (PDSCH) link adaptation.

In LTE and NR, the SRS is configured via radio resource control (RRC) and some parts of the configuration can be updated (for reduced latency) by medium access control (MAC) control element (CE) signaling. The configuration includes the SRS resource allocation (the physical mapping and sequence to use) as well as the time (aperiodic/semi-persistent/periodic) behavior. For aperiodic SRS transmission, the RRC configuration does not activate an SRS transmission from the user equipment (UE), but instead a dynamic activation trigger is transmitted via the physical downlink control channel (PDCCH)'s downlink control information (DCI) in the DL from the gNodeB (gNB) to order the UE to transmit the SRS once, at a predetermined time.

### SRS Configuration

The SRS configuration allows generating an SRS transmission pattern based on an SRS resource configuration grouped into SRS resource sets. Each SRS resource is configured with the following abstract syntax notation (ASN) code in RRC (see 3GPP 38.331 version 16.1.0):

| | |
|---|---|
| SRS-Resource ::= | SEQUENCE { |
| srs-ResourceId | SRS-ResourceId, |
| nrofSRS-Ports | ENUMERATED {port1, ports2, ports4}, |
| ptrs-PortIndex | ENUMERATED {n0, n1 } |
| OPTIONAL, -- Need R | |
| transmissionComb | CHOICE { |
| n2 | SEQUENCE { |
| combOffset-n2 | INTEGER (0..1), |
| cyclicShift-n2 | INTEGER (0..7) |
| }, | |
| n4 | SEQUENCE { |
| combOffset-n4 | INTEGER (0..3), |
| cyclicShift-n4 | INTEGER (0..11) |
| } | |
| }, | |
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |
| }, | |
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |
| }, | |
| groupOrSequenceHopping | ENUMERATED { neither, groupHopping, |
| sequenceHopping }, | |
| resourceType | CHOICE { |
| aperiodic | SEQUENCE { |
| ... | |
| }, | |
| semi-persistent | SEQUENCE { |
| periodicity AndOffset-sp | SRS-PeriodicityAndOffset, |
| ... | |
| }, | |
| periodic | SEQUENCE { |
| periodicity AndOffset-p | SRS-PeriodicityAndOffset, |
| ... | |
| } | |
| }, | |
| sequenceId | INTEGER (0..1023), |
| spatialRelationInfo | SRS-SpatialRelationInfo OPTIONAL, |
| -- Need R | |
| ..., | |
| [[ | |
| resourceMapping-r16 | SEQUENCE { |
| startPosition-r16 | INTEGER (0..13), |
| nrofSymbols-r16 | ENUMERATED {n1, n2, n4}, |
| repetitionFactor-r16 | ENUMERATED {n1, n2, n4} |
| } | OPTIONAL -- Need R |
| ]] | |
| } | |
| | * * * * * * * * * * |

To create the SRS resource on the time-frequency grid with the current RRC configuration, each SRS resource is thus configurable with respect to:
The transmission comb (i.e., mapping to every n^{th} subcarrier, where n=2 or n=4), configured by the RRC parameter transmissionComb.
   For each SRS resource, a comb offset, configured by the RRC parameter combOffset, is specified (i.e., which of the n combs to use).
   A cyclic shift, configured by the RRC parameter cyclicShift, that maps the SRS sequence to the assigned comb, is also specified. The cyclic shift increases the number of SRS resources that can be mapped to a comb, but there is a limit on how many cyclic shifts that can be used that depends on the transmission comb being used.
The time-domain position of an SRS resource within a given slot is configured with the RRC parameter resourceMapping.
   A time-domain start position for the SRS resource, which is limited to be one of the last 6 symbols in a slot, is configured by the RRC parameter startPosition.
   A number of orthogonal frequency-division multiplexing (OFDM) symbols for the SRS resource (that can be set to 1, 2 or 4) is configured by the RRC parameter nrofSymbols.
   A repetition factor (that can be set to 1, 2 or 4) configured by the RRC parameter repetitionFactor. When this parameter is larger than 1, the same frequency resources are used multiple times across OFDM symbols, used to improve the coverage as more energy is collected by the receiver. It can also be used for beam-management functionality, where the gNB can probe different receive beams for each repetition.
The frequency-domain sounding bandwidth and position of an SRS resource in a given OFDM symbol (i.e., which part of the system bandwidth is occupied by the SRS resource) is configured with the RRC parameters freqDomainPosition, freqDomainShift and the freqHopping parameters: c-SRS, b-SRS and b-hop. The smallest possible sounding bandwidth in a given OFDM symbol is 4 resource blocks (RBs).

FIG. 1 provides a schematic description of how an SRS resource is allocated in time and frequency in a given OFDM symbol within a slot (if resourceMapping-r16 is not signaled). Note that c-SRS controls the maximum sounding bandwidth, which can be smaller than the maximum transmission bandwidth the UE supports. For example, the UE may have capability to transmit over 40 MHz bandwidth, but c-SRS is set to a smaller value corresponding to 5 MHz, thereby focusing the available transmit power to a narrowband transmission which improves the SRS coverage.

In NR release 16, an additional RRC parameter called resourceMapping-r16 was introduced. If resourceMapping-r16 is signaled, the UE shall ignore the RRC parameter resourceMapping. The difference between resourceMapping-r16 and resourceMapping is that the SRS resource (for which the number of OFDM symbols and repetition factor is still limited to 4) can start in any of the 14 OFDM symbols (see FIG. 2) within a slot, configured by the RRC parameter startPosition-r16. FIG. 2 provides a schematic description of how an SRS resource is allocated in time and frequency within a slot if resourceMapping-r16 is signaled.

The RRC parameter resourceType configures whether the resource is transmitted as periodic, aperiodic (single transmission triggered by DCI), or semi persistent (same as periodic but the start and stop of the periodic transmission is controlled by Medium Access Control (MAC) Control Element (CE) signaling instead of RRC signaling). The RRC parameter sequenceId specifies how the SRS sequence is initialized and the RRC parameter spatialRelationInfo configures the spatial relation for the SRS beam with respect to a reference signal (RS) which can be either another SRS, synchronization signal block (SSB) or CSI-RS. Hence, if the SRS has a spatial relation to another SRS, then this SRS should be transmitted with the same beam (i.e., spatial transmit filter) as the indicated SRS.

The SRS resource is configured as part of an SRS resource set. Within a set, the following parameters (common to all resources in the set) are configured in RRC:
The associated CSI-RS resource (this configuration is only applicable for non-codebook-based UL transmission) for each of the possible resource types (aperiodic, periodic and semi persistent). For aperiodic SRS, the associated CSI-RS resource is set by the RRC parameter csi-RS. For periodic and semi-persistent SRS, the associated CSI-RS resource is set by the RRC parameter associatedCSI-RS. Note that all resources in a resource set must share the same resource type.
For aperiodic resources, the slot offset is configured by the RRC parameter slotOffset and sets the delay from the PDCCH trigger reception to start of the transmission of the SRS resources measured in slots.
The resource usage, which is configured by the RRC parameter usage sets the constraints and assumption on the resource properties (see 3GPP 38.214).
The power-control RRC parameters alpha, p0, pathlossReferenceRS (indicating the downlink reference signal (RS) that can be used for path-loss estimation), srs-PowerControlAdjustmentStates, and pathlossReferenceRSList-r16 (for NR release 16), which are used for determining the SRS transmit power.

Each SRS resource set is configured with the following ASN code in RRC (see 3GPP 38.331 version 16.1.0):

| | |
|---|---|
| SRS-ResourceSet ::= | SEQUENCE |
| srs-ResourceSetId | SRS-ResourceSetId, |
| srs-ResourceIdList | SEQUENCE (SIZE(1..maxNrofSRS-ResourcesPerSet) |

OF SRS-ResourceId OPTIONAL, -- Cond Setup

| | |
|---|---|
| resourceType | CHOICE { |
| aperiodic | SEQUENCE { |

aperiodicSRS-ResourceTrigger INTEGER (1..maxNrofSRS-TriggerStates-1),

| | |
|---|---|
| csi-RS | NZP-CSI-RS-ResourceId |

OPTIONAL, -- Cond NonCodebook

| | |
|---|---|
| slotOffset | INTEGER (1..32) |
| OPTIONAL, -- Need S | |
| ..., | |
| [[ | |

aperiodicSRS-ResourceTriggerList SEQUENCE (SIZE(1..maxNrofSRS-

| | |
|---|---|
| TriggerStates-2)) | |
| | OF INTEGER (1..maxNrofSRS-TriggerStates-1) |
| OPTIONAL -- Need M | |
| ]] | |
| }, | |
| semi-persistent | SEQUENCE { |
| associatedCSI-RS | NZP-CSI-RS-ResourceId |

OPTIONAL, -- Cond NonCodebook

| | |
|---|---|
| ... | |
| }, | |
| periodic | SEQUENCE { |
| associatedCSI-RS | NZP-CSI-RS-ResourceId |

OPTIONAL, -- Cond NonCodebook

```
      ...
    }
  },
```

```
  usage ENUMERATED {beamManagement, codebook,
nonCodebook, antennaSwitching},
  alpha Alpha
```

OPTIONAL, -- Need S

p0 INTEGER (−202..24)

| | |
|---|---|
| OPTIONAL, -- Cond Setup | |
| pathlossReferenceRS | PathlossReferenceRS-Config |
| OPTIONAL, -- Need M | |

srs-PowerControlAdjustmentStates ENUMERATED { sameAsFci2,

| | |
|---|---|
| separateClosedLoop} | OPTIONAL, -- Need S |
| ..., | |
| [[ | |
| pathlossReferenceRSList-r16 | SetupRelease { PathlossReferenceRSList-r16} |
| OPTIONAL -- Need M | |
| ]] | |
| } | |
| | * * * * * * * * * * |

Hence it can be seen that in terms of resource allocation, the SRS resource set configures usage, power control, aperiodic transmission timing, and DL resource association. The SRS resource configuration controls the time-and-frequency allocation, the periodicity and offset of each resource, the sequence ID for each resource and the spatial-relation information.

### Resource Mapping to Antenna Ports

SRS resources can be configured with four different usages: ‘beamManagement’, ‘codebook’, ‘nonCodebook’ or ‘antennaSwitching’.

SRS resources in an SRS resource set configured with usage ‘beamManagement’ are mainly applicable for frequency bands above 24 GHz (i.e., for frequency range 2 (FR2)) and the purpose is to allow the UE to evaluate different UE transmit beams for wideband (e.g. analog) beamforming arrays. The UE will then transmit one SRS resource per wideband beam in different OFDM symbols, and the gNB will perform reference signal received power (RSRP) measurement on each of the transmitted SRS resources and in this way determine a suitable UE transmit beam. The gNB can then inform the UE which transmit beam to use by updating the spatial relation for different UL channels. It is expected that the gNB will configure the UE with one SRS resource set with usage ‘beamManagement’ for each analog array (panel) that the UE has.

SRS resources in an SRS resource set configured with usage ‘codebook’ are used to sound the different UE antennas and let the gNB determine suitable precoders, rank and MCS for PUSCH transmission. How each SRS port is mapped to each UE antenna is up to UE implementation, but it is expected that one SRS port will be transmitted per UE antenna, i.e. the SRS port to antenna-port mapping will be an identity matrix.

SRS resources in an SRS resource set configured with usage ‘nonCodebook’ are used to sound different potential precoders, autonomously determined by the UE. The UE determines a set of precoder candidates based on reciprocity, transmits one SRS resource per candidate precoder, and the gNB can then, by indicating a subset of these SRS resources, select which precoder(s) the UE should use for PUSCH transmission. One UL layer will be transmitted per indicated SRS, hence candidate precoder. How the UE maps the SRS resources to the antenna ports is up to UE implementation and depends on the channel realization.

SRS resources in an SRS resource set configured with usage ‘antennaSwitching’ are used to sound the channel in the UL so that the gNB can use reciprocity to determine suitable DL precoders. If the UE has the same number of transmit and receive chains, the UE is expected to transmit one SRS port per UE antenna. The mapping from SRS ports to antenna ports is, however, up to the UE to decide and is transparent to the gNB.

### SRS Coverage

Uplink coverage for SRS is identified as a bottleneck for NR and a limiting factor for DL reciprocity-based operation. Some measures to improve the coverage of SRS have been adopted in NR, for example repetition of an SRS resource and/or frequency hopping. FIG. 3 illustrates one example of SRS transmission using frequency hopping. In FIG. 3, different parts of the frequency band are sounded in different OFDM symbols, which means that the power spectral density (PSD) for the SRS will improve. Here, the illustrated frequency-hopping pattern is set according to Section 6.4 of 3GPP 38.211. FIG. 4 illustrates one example of SRS transmission using repetition. In FIG. 4, one SRS resource is transmitted in four consecutive OFDM symbols, which will increase the processing gain of the SRS.

### SRS Power Scaling

SRS has its own UL power control (PC) scheme in NR, which can be found in Section 7.3 of 3GPP 38.213. Section 7.3 in 38.213 additionally specifies how the UE should split the above output power between two or more SRS ports during one SRS transmit occasion (an SRS transmit occasion is a time window within a slot where SRS transmission is performed). Specifically, the UE splits the transmit power equally across the configured antenna ports and bandwidth for SRS. Hence, the received signal-to-noise ratio (SNR) per occupied subcarriers of an SRS is inversely proportional to the number of occupied subcarriers. It is important to note that the decrease in knowledge of the channel state does not generally drop in direct proportion to the decrease in the number of occupied subcarriers. For example, a frequency-flat channel between two antennas can be modeled with by a single complex constant. Therefore, a relatively narrowband SRS transmission can be sufficient for good channel-state estimation.

### SRS-Based Estimation of Physical Channel Parameters

The SRS can also be used to estimate physical channel parameters, e.g., the angle and delay of propagation paths, which are wideband parameters that do not depend on the carrier frequency.

### Guard Period for Antenna Switching

For SRS with usage set to ‘antennaSwitching’, a minimum guard period is configured between the SRS resources to account for transmit-antenna switching transient time. In 38.214 Table 6.2.1.2-1, (see FIG. 5), the minimum number of OFDM symbols used as guard period between two SRS resources belonging to the same SRS resource set is determined. As shown in the table of FIG. 5, the minimum guard period is 1 OFDM symbol for the case when the subcarrier spacing (SCS) is smaller than 120 kHz and 2 OFDM symbols for the case when the SCS is 120 kHz. SRS resource #1 is used to sound the first SRS port and SRS resource #2 is used to sound the second SRS port.

### SUMMARY

There currently exist certain challenge(s). Using a transmission comb of every 2^{nd} or every 4^{th} subcarrier for SRS transmission increases the received SNR per occupied subcarriers by approximately 3 or 6 dB, respectively. The delay-domain resolution is, however, not (significantly) affected by using a transmission comb over the sounded bandwidth. However, as the occupied subcarriers become spaced further apart as the transmission comb increases, the sequence length for a given bandwidth decreases. Shorter sequence lengths provide less interference averaging. Furthermore, for frequency-selective channels, interpolating the channel estimate between the occupied subcarriers typically results in increased channel-estimation errors for the non-occupied subcarriers. For delay estimation, a high-order transmission comb may also lead to aliasing in the delay domain, as the ambiguity range is inversely proportional to the sampling interval in frequency domain.

An alternative way to reduce the number of occupied subcarriers is to transmit SRS in a subset of the physical resource blocks (PRBs) available within the system bandwidth. Frequency-selective transmission is already supported in both LTE and NR. However, as described above, SRS is transmitted in multiples of 4 contiguous PRBs. A disadvantage of using a minimum number of contiguous PRBs is that it will put a limit on the maximum SNR per occupied subcarriers. Another constraint in the current specification is that the SRS frequency-hopping pattern is determined with a single predefined function. A disadvantage of using a fixed frequency-hopping pattern is that the scheduler can't trade off channel knowledge for occupied PRBs in a good way. For example, distributing the occupied PRBs farther apart for large correlation bandwidths can provide better channel knowledge while maximizing received SRS SNR. As an example, UEs in poor channel conditions may be power limited and will not need to transmit SRS over large frequency domain allocations, in which case the PRBs that a UE's SRS occupy should be flexibly set according to the UEs to be scheduled.

Certain aspects of the present disclosure and their embodiments may provide solutions to these or other challenges. Certain embodiments propose a more flexible frequency allocation for SRS resources, by, for example, allowing sparse regular/irregular PRB allocation, irregular transmission comb/comb offset, and increased subcarrier spacing (SCS), etc. Certain embodiments propose signalling to implement the more flexible frequency allocation for SRS resources.

There are, proposed herein, various embodiments which address one or more of the issues disclosed herein. As an example, in certain embodiments, an SRS configuration enables the UE to sound non-contiguous parts of the BW, either with regular or irregular frequency-domain PRB patterns. As another example, in certain embodiments, an SRS configuration may comprise a transmission comb and/or comb offset and/or cyclic shift configured differently in different PRBs spanning an SRS resource. As another example, certain embodiments configure higher SCS for SRS transmission than PUSCH SCS, enabling faster beam sweeping or antenna switching, sounding of wider bandwidth, interference averaging, etc.

According to certain embodiments, a method performed by a wireless device comprises determining a configuration for SRS transmission. The configuration is determined at least in part based on information received from a network node. The method further comprises performing the SRS transmission according to the configuration.

According to certain embodiments, a wireless device comprises power supply circuitry and processing circuitry. The power supply circuitry is configured to supply power to the wireless device. The processing circuitry is configured to determine a configuration for SRS transmission. The configuration is determined at least in part based on information received from a network node. The processing circuitry is configured to perform the SRS transmission according to the configuration.

Certain embodiments of the above-described wireless device and/or method performed by a wireless device may comprise any suitable additional features, such as one or more of the following features:

In certain embodiments, the configuration for the SRS transmission comprises non-contiguous parts of a frequency-domain sounding bandwidth in a given OFDM symbol.

In certain embodiments, the configuration configures a transmission comb differently in different PRBs spanning an SRS resource.

In certain embodiments, the configuration configures a comb offset differently in different PRBs spanning an SRS resource.

In certain embodiments, the configuration configures a cyclic shift differently in different PRBs spanning an SRS resource.

In certain embodiments, each of a plurality of PRBs of an SRS resource belongs to the same OFDM symbol.

In certain embodiments, at least one PRB of an SRS resource belongs to a different OFDM symbol than at least one other PRB of the SRS resource.

In certain embodiments, the configuration varies a comb configuration over sounded PRBs in an irregular pattern.

In certain embodiments, the configuration varies a comb configuration over sounded PRBs in different SRS resources.

In certain embodiments, the information received from the network node explicitly signals a set of PRBs that are occupied by a given SRS and which transmission comb to use in each PRB. As an example, the information received from the network node comprises a first bit map indicating the set of PRBs that are occupied by the given SRS and a second bit map indicating which transmission comb to use in each PRB.

In certain embodiments, the information received from the network node indicates one out of multiple pre-determined PRB allocations and comb configurations.

In certain embodiments, the configuration configures an SCS used for the SRS transmission differently than an SCS used for a PUSCH. As an example, the SCS used for the SRS transmission is higher than the SCS used for the PUSCH. In certain embodiments, the SCS used for the SRS transmission is configured with usage beamManagement.

In certain embodiments, the configuration configures a regular frequency-domain PRB pattern.

In certain embodiments, the configuration configures an irregular frequency-domain PRB pattern.

Certain embodiments further comprise receiving the information used for determining the configuration for the SRS transmission from the network node via RRC signaling.

According to certain embodiments, a method performed by a network node comprises determining information indicating at least a portion of a configuration for SRS transmission and sending the information to the wireless device.

According to certain embodiments, a network node comprises power supply circuitry and processing circuitry. The power supply circuitry is configured to supply power to the network node. The processing circuitry is configured to determine information indicating at least a portion of a configuration for SRS transmission and to send the information to the wireless device.

Certain embodiments of the above-described network node and/or method performed by a network node may comprise any suitable additional features, such as one or more of the following features:

In certain embodiments, the configuration for the SRS transmission comprises non-contiguous parts of a frequency-domain sounding bandwidth in a given OFDM symbol.

In certain embodiments, the configuration configures a transmission comb differently in different PRBs spanning an SRS resource.

In certain embodiments, the configuration configures a comb offset differently in different PRBs spanning an SRS resource.

In certain embodiments, the configuration configures a cyclic shift differently in different PRBs spanning an SRS resource.

In certain embodiments, each of a plurality of PRBs of an SRS resource belongs to the same OFDM symbol.

In certain embodiments, at least one PRB of an SRS resource belongs to a different OFDM symbol than at least one other PRB of the SRS resource.

In certain embodiments, the configuration varies a comb configuration over sounded PRBs in an irregular pattern.

In certain embodiments, the configuration varies a comb configuration over sounded PRBs in different SRS resources.

In certain embodiments, the information sent to the wireless device explicitly signals a set of PRBs that are occupied by a given SRS and which transmission comb to use in each PRB. As an example, the information sent to the wireless device comprise a first bit map indicating the set of PRBs that are occupied by the given SRS and a second bit map indicating which transmission comb to use in each PRB.

In certain embodiments, the information sent to the wireless device indicates one out of multiple pre-determined PRB allocations and comb configurations. As an example, certain embodiments select the one out of the multiple pre-determined PRB allocations and comb configurations. In certain embodiments, the selection is based on intermodulation properties associated with the pre-determined PRB allocations and comb configurations. In certain embodiments, the selection is based on time-delay estimation properties associated with the pre-determined PRB allocations and comb configurations.

In certain embodiments, the configuration configures an SCS used for the SRS transmission differently than an SCS used for a PUSCH. As an example, the SCS used for the SRS transmission is higher than the SCS used for the PUSCH. In certain embodiments, the SCS used for the SRS transmission is configured with usage beamManagement

In certain embodiments, the configuration configures a regular frequency-domain PRB pattern.

In certain embodiments, the configuration configures an irregular frequency-domain PRB pattern.

In certain embodiments, the information is sent to the wireless device via RRC signaling.

Certain embodiments receive the SRS transmission from the wireless device according to the configuration.

Certain embodiments may provide one or more of the following technical advantage(s). Depending on the use case, allowing a flexible frequency allocation of SRS transmissions can bring various benefits, for example: increasing time-domain resolution for delay estimation, spreading inter-modulation products over frequency to reduce out-of-band emission, decreasing antenna switching or beam sweeping time, etc.

### BRIEF DESCRIPTION OF THE FIGURES

For a more complete understanding of the disclosed embodiments and their features and advantages, reference is now made to the following description, taken in conjunction with the accompanying drawings, in which:

FIG. 1: Schematic description of how an SRS resource is allocated in time and frequency within a slot if resourceMapping-r16 is not signaled

FIG. 2: Schematic description of how an SRS resource is allocated in time and frequency within a slot if resourceMapping-r16 is signaled.

FIG. 3: SRS transmission using frequency hopping.

FIG. 4: SRS transmission using repetition.

FIG. 5: Minimum guard period between two SRS resources of an SRS resource set for antenna switching.

FIG. 6: SRS transmission spanning 4 contiguous PRBs (as in NR release 16) in accordance with some embodiments.

FIG. 7: SRS transmission spanning 4 non-contiguous PRBs in accordance with some embodiments.

FIG. 8: SRS transmission spanning 4 non-contiguous combined with repetition in accordance with some embodiments.

FIG. 9: SRS transmission spanning 4 non-contiguous PRBs (per sounding) combined with frequency hopping in accordance with some embodiments.

FIG. 10: Irregular SRS transmission spanning 4 non-contiguous PRBs in accordance with some embodiments.

FIG. 11: SRS transmission spanning 4 contiguous PRBs for which the comb configuration varies oved the sounded PRBs in accordance with some embodiments.

FIG. 12: SRS transmission spanning 4 non-contiguous PRBs for which the comb configuration varies oved the sounded PRBs in accordance with some embodiments.

FIG. 13: A wireless network in accordance with some embodiments.

FIG. 14: User Equipment in accordance with some embodiments.

FIG. 15: Virtualization environment in accordance with some embodiments.

FIG. 16: Telecommunication network connected via an intermediate network to a host computer in accordance with some embodiments.

FIG. 17: Host computer communicating via a base station with a user equipment over a partially wireless connection in accordance with some embodiments.

FIG. 18: Methods implemented in a communication system including a host computer, a base station and a user equipment in accordance with some embodiments.

FIG. 19: Methods implemented in a communication system including a host computer, a base station and a user equipment in accordance with some embodiments.

FIG. 20: Methods implemented in a communication system including a host computer, a base station and a user equipment in accordance with some embodiments.

FIG. 21: Methods implemented in a communication system including a host computer, a base station and a user equipment in accordance with some embodiments.

FIG. 22: Method implemented in a wireless device in accordance with some embodiments.

FIG. 23: Virtualization apparatus in accordance with some embodiments.

FIG. 24: Method implemented in a network node in accordance with some embodiments.

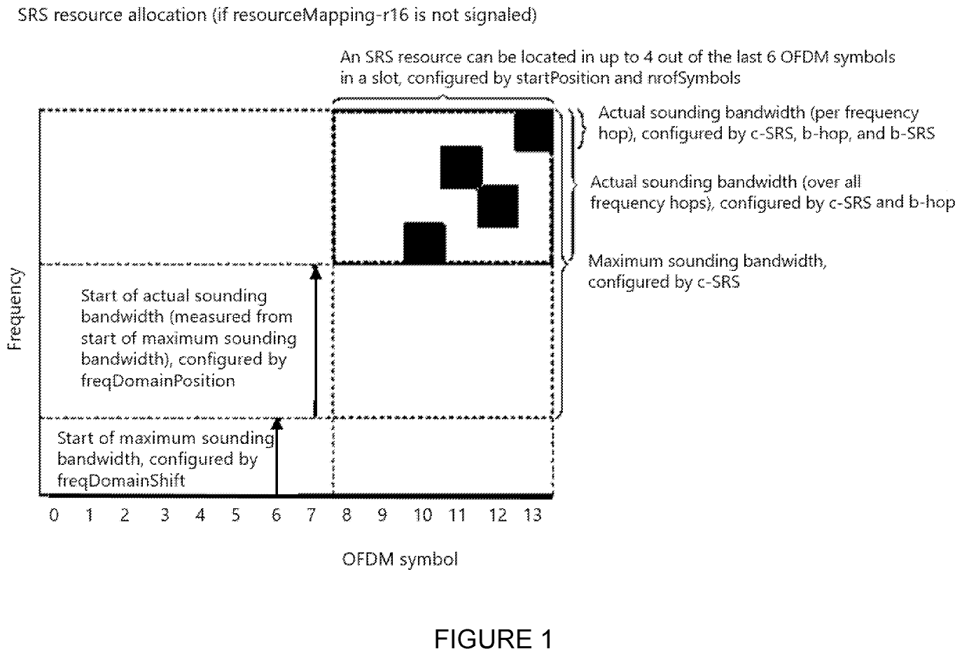

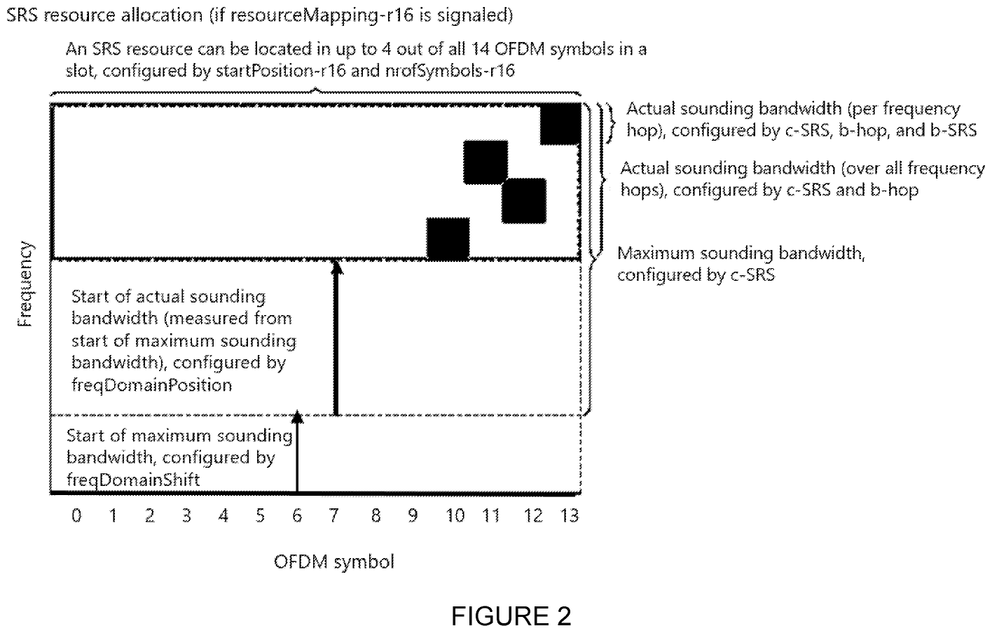

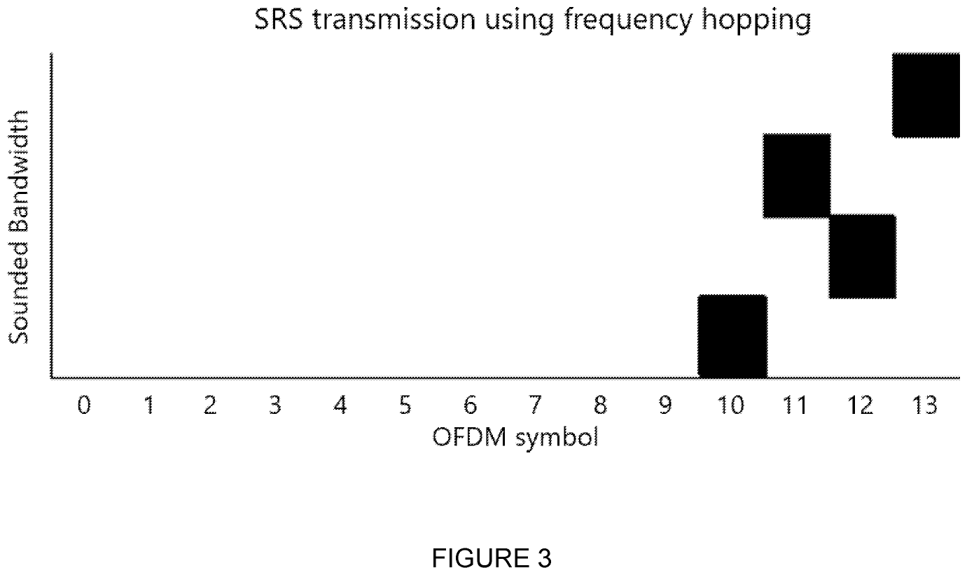

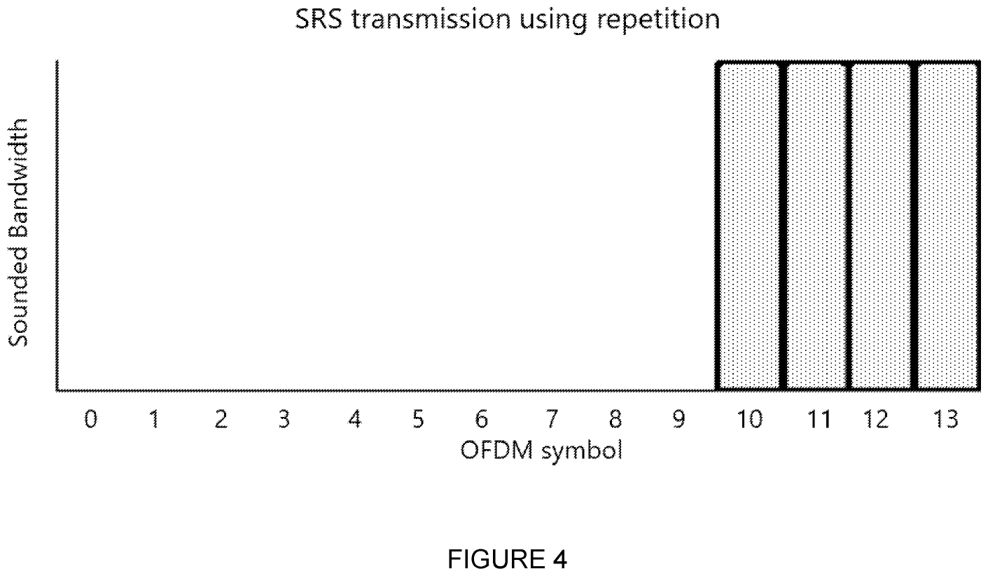

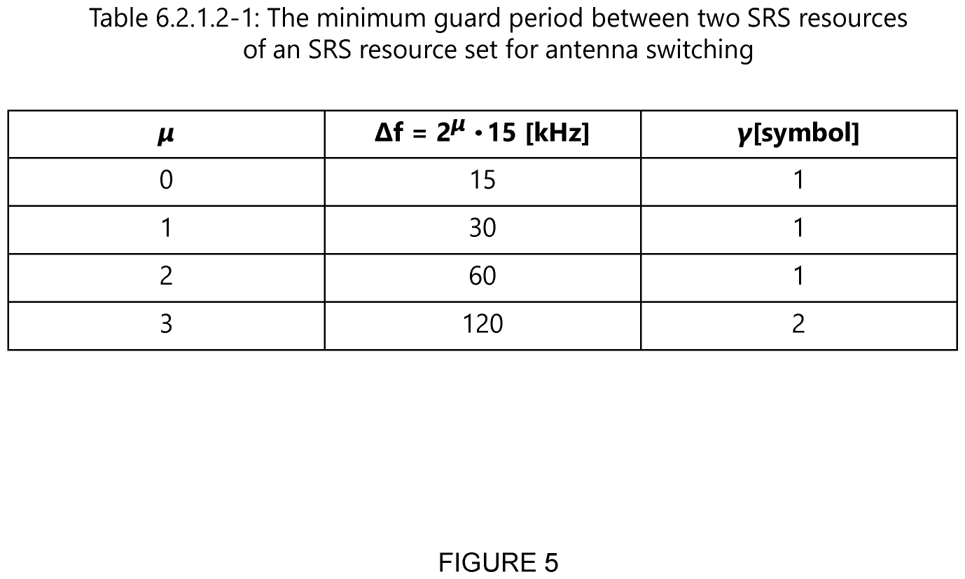

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

### Embodiment 1: Non-Contiguous Regular/Irregular Frequency-Domain PRB Patterns

In this first embodiment the PRBs occupied for an SRS transmission can be allocated in a non-contiguous (and, possibly, sparse and/or irregular) way compared to what is allowed in the current NR specification (NR release 16, to be more precise). The advantage of using non-contiguous PRBs for SRS transmissions includes that a wider frequency range could be sounded with a fixed number of PRBs, which improves the time-domain resolution and provides robustness towards fading dips), without suffering from the drawbacks of decreasing the SNR per occupied subcarrier and sacrificing multiplexing capabilities (as the number of occupied subcarriers does not change).

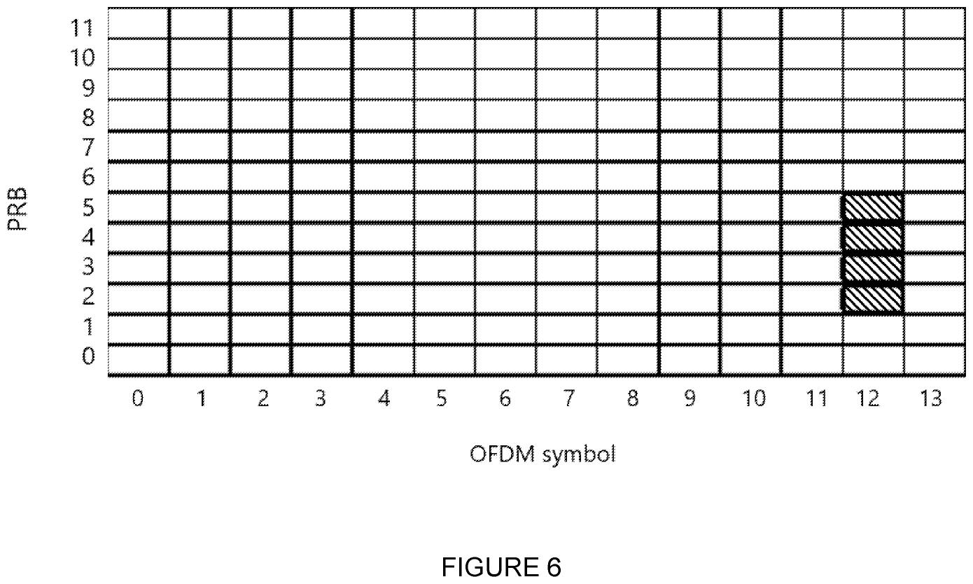

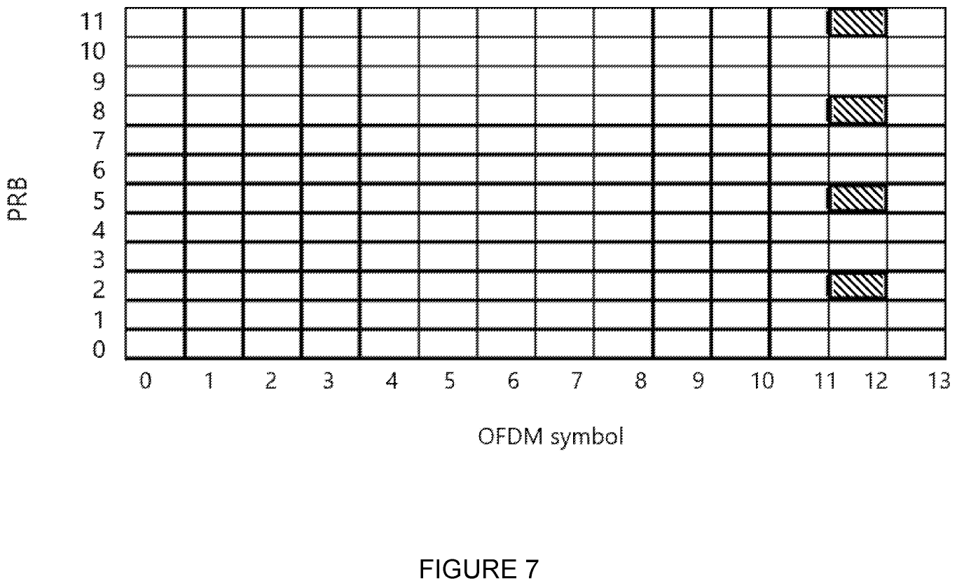

In one example of this embodiment, non-contiguous SRS transmission can be configured by introducing an additional binary field called freqDomainSparse in the RRC configuration for an SRS resource. If freqDomainSparse=0, SRS is configured as in current (NR release 16) specification. However, if freqDomainSparse=1, SRS is configured to be non-contiguous. FIG. 6 provides an example of how a narrowband SRS transmission (spanning 4 PRBs) could look like with SRS resource configuration as in NR release 16 (i.e., if freqDomainSparse=0). Specifically, the SRS resource allocation shown in FIG. 6 can be configured in RRC by, e.g., setting c-SRS=2 (such that the maximum sounding bandwidth is), b-hop=1, b-SRS=1, freqDomainShift=2 (such that the SRS start in the third PRB within the maximum sounding bandwidth), startPosition=1, nrofSymbols=1, and repetitionFactor=1. FIG. 7 provides an example of how a non-contiguous SRS transmission (spanning 4 PRBs), as proposed in this example of this embodiment, could look like. The only difference compared to the SRS in FIG. 6 is that freqDomainSparse=1 in the RRC configuration. Here, the sounded PRBs are spaced equidistantly within the maximum sounding bandwidth starting from the PRB configured by the RRC parameter freqDomainShift.

Note that, in current NR specification, the only way to sound the frequency range spanned by the SRS in FIG. 7 is to configure an SRS that span 12 contiguous PRBs, i.e., to use three times more resources compared to the 4 PRBs occupied by the SRS transmission in FIG. 7. By using a subset of the available PRBs (and, hence, a subset of the available subcarriers) for SRS, more UEs can share a given set of subcarriers (i.e., more UEs can be multiplexed onto a limited set of time-frequency resources).

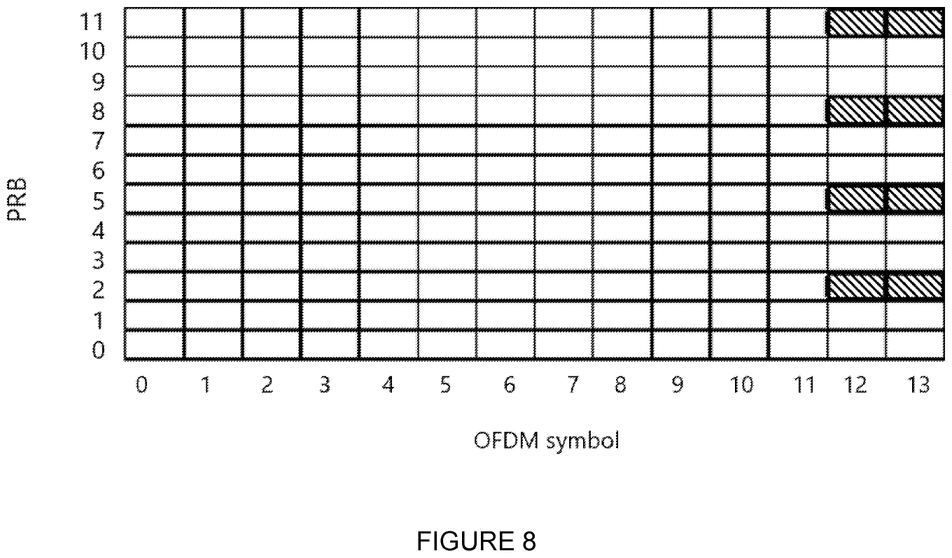

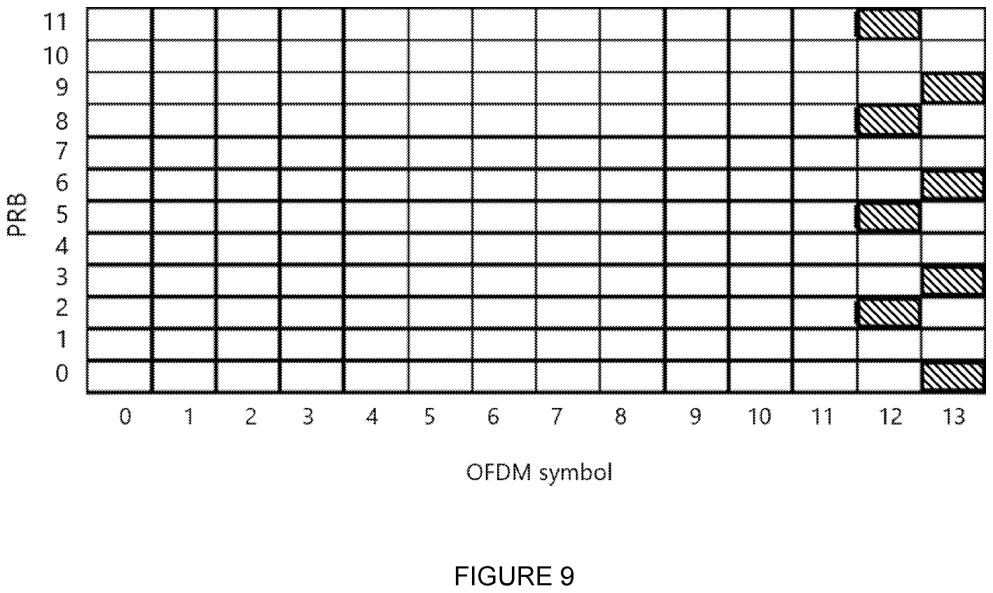

It is straightforward to support also repetition and frequency hopping for non-contiguous SRS transmission. In one example of this embodiment, non-contiguous repetition, as illustrated in FIG. 8, could be supported by setting nrofSymbols=2, and repetitionFactor=2 while keeping freqDomainSparse=1 and the rest of the RRC parameters as above. Non-contiguous frequency hopping, as illustrated in FIG. 9, could be supported by setting nrofSymbols=2, and b-hop=0 while keeping freqDomainSparse=1 and the rest of the RRC parameters as above.

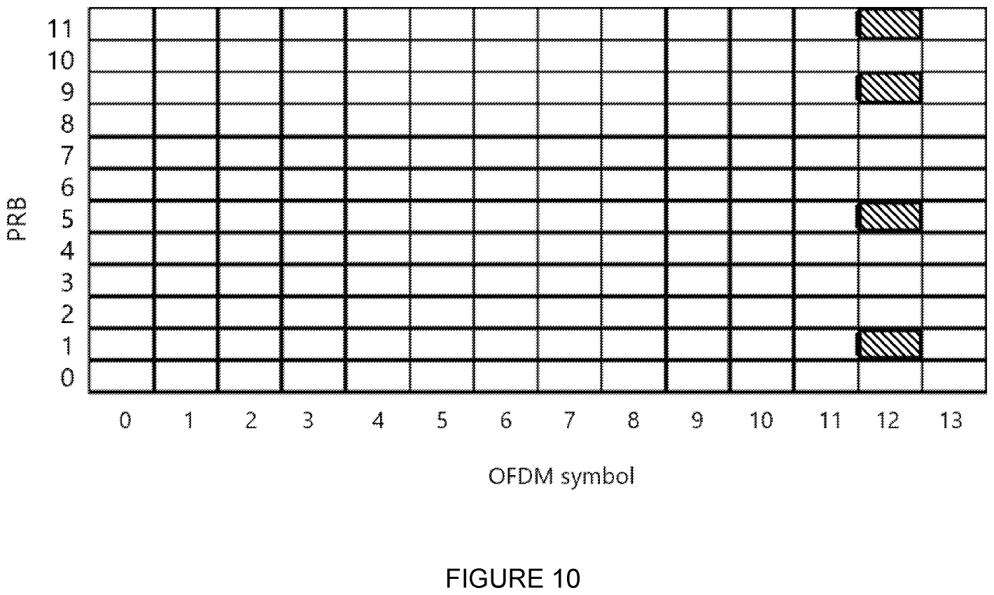

In another example of this embodiment, the PRBs of an SRS transmission is determined such that the intermodulation products can be better controlled. If every n^{th} PRB is occupied, intermodulation products tend to land on the same frequencies. However, if the occupied PRBs can be selected in a more flexible and irregular way, the intermodulation products can be better spread out in frequency, thereby making it easier to meet out-of-band emission requirements. Another potential advantage with using irregular PRB allocation in the frequency domain could be to mitigate delay-domain ambiguities. This could for example be beneficial when SRS is used to estimate time domain delays in the channel. An example of irregular PRB allocation is shown in FIG. 10.

In one aspect of this embodiment, the UE is indicated a subset of a contiguous set of PRBs in which to transmit an SRS. The UE transmits SRS only in the indicated subset, such that some of the PRBs of the contiguous set are unoccupied. Which PRBs that are occupied for a given SRS can either be signaled explicitly (for example by a bit map, where each bit in the bit map correspond to one PRB, and a “1” in the bitmap indicates that the PRB will be used for SRS transmission and a “0” indicates that the PRB will not be used for the SRS transmission), or, a signal can indicate one out of multiple pre-determined PRB allocations (that has been designed for different beneficial purposes, for example to generate low intermodulation or good time-delay estimation properties). In an embodiment where frequency hopping is used, a list of starting PRB offsets that defines where the contiguous set of PRBs starts for each hop is determined according to a predetermined function. In such embodiments, the starting PRB could also be signaled (e.g., using the already existing RRC parameter freqDomainShift).

### Embodiment 2: Varying Transmission Comb, Comb Offset, and Cyclic Shift

This embodiment introduces the possibility to use a comb configuration in different PRBs spanned by an SRS resource. The advantages of allowing different comb configurations in different PRBs spanned by an SRS resource are similar to the advantages of sounding irregular PRBs and include spreading out intermodulation products over frequency (which makes it easier to satisfy out-of-band requirements) as well as mitigating delay-domain ambiguities. Using different comb configurations in different PRBs also has the potential to randomize and, hence, mitigate interference from UEs transmitting in the same PRBs.

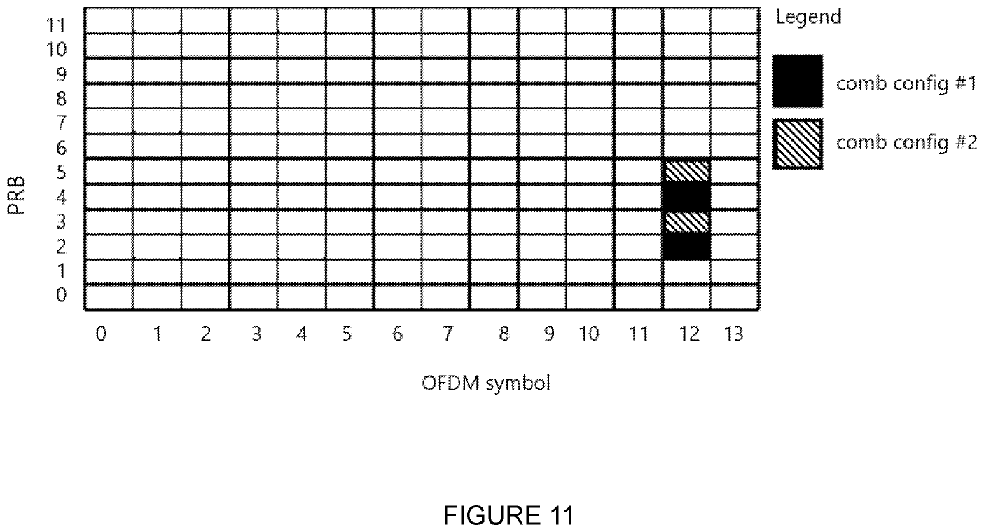

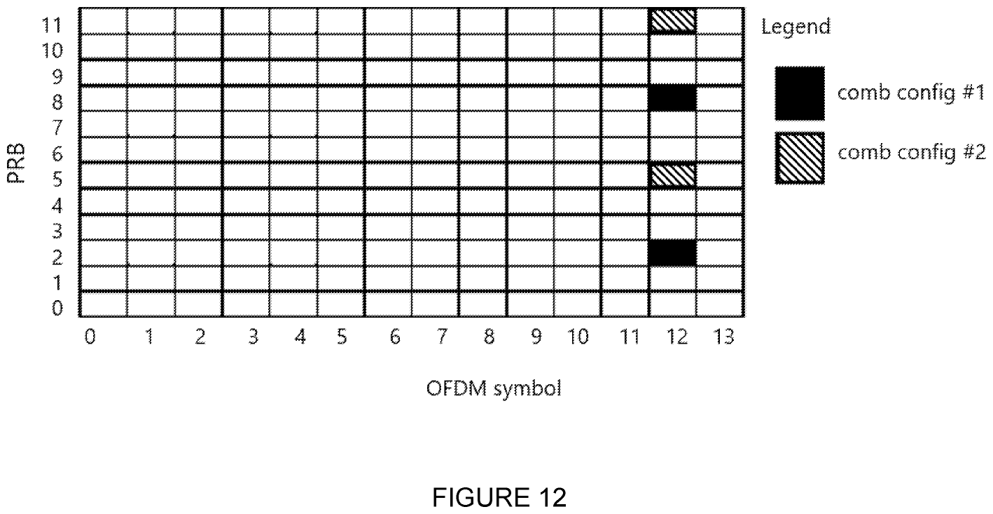

In one example of this embodiment, P comb configurations (signaled to the UEs using RRC), where a comb configuration could include, e.g., the transmission comb, the comb offset and the cyclic shift, are configured for an SRS resource for which the mod(p, P)th comb configuration is used in the pth PRB. FIG. 11 illustrates how the comb configuration could vary over the sounded bandwidth for a single-symbol SRS resource spanning 4 contiguous PRBs (c.f. FIG. 6), and FIG. 12 illustrates how the comb configuration could vary over the sounded bandwidth for a single-symbol SRS resource spanning 4 non-contiguous PRBs (c.f. FIG. 7). In both these examples, it holds that transmissionComb=2, combOffset=0 and cyclicShift=0 for comb configuration #1 and that transmissionComb=4, combOffset=2 and cyclicShift=] for comb configuration #2.

The comb configuration could also be varied over the sounded PRBs in an irregular pattern. In one aspect of this embodiment, the UE is indicated a subset of a contiguous set of PRBs in which to transmit an SRS. The UE transmits SRS only in the indicated subset, such that some of the PRBs of the contiguous set are unoccupied. Which PRBs that are occupied by a given SRS and which transmission comb that should be used in that PRB can either be signaled explicitly (for example by two bit maps, where each bit in the first bit map indicates that the PRB will be sounded and the second bit map indicates which transmission comb to use in each PRB), or, a signal can indicate one out of multiple pre-determined PRB allocations and comb configurations (that has been designed for different beneficial purposes, for example to generate low intermodulation or good time-delay estimation properties).

So far, the description of this embodiment of the invention has focused on varying the comb configuration over the PRBs sounded by an SRS resource. The idea of varying the comb configuration over the sounded PRBs could be extended to PRBs in different SRS resources (e.g., in different slots).

### Embodiment 3: Configured SRS Subcarrier Spacing

This embodiment introduces the possibility to configure an SRS SCS that is different from the PUSCH SCS. Typically, a larger SCS than the PUSCH SCS. A number of different alternatives for this embodiment are listed below:
The SCS for an SRS can be part of an SRS resource/SRS resource set configuration and signaled with RRC.
SCS for SRS can be dynamic. If triggered aperiodically and different trigger points have SRS resources which have different SCS. Alternatively, a new bitfield in a DCI triggering an SRS transmission can be used to indicate one of multiple pre-configured SCSs for SRS. For periodic or semi-persistent SRS resources, indication of one of multiple pre-configured SCS can be done by MAC CE signaling.

When SCS is increased X times, then the transmitted SRS resources can span (up to) X times more OFDM symbols of the higher SCS to fill an OFDM symbol of the lower SCS. Dividing one SRS resource in one OFDM symbol to several shorter SRS resources, will reduce the power per SRS resource. However, in some cases the SRS link budget is not a problem, for example if the UE is in good channel conditions. Also, for some use cases (e.g., Frequency Division Duplex (FDD) reciprocity), the only thing the receiver is interested in is the energy and received direction, no need for, e.g., accurate phase estimation, hence a bit less power per SRS resource might not have a large effect on the overall performance. In cases where SRS link budget needs to be maintained, this can be achieved by increasing by X times either the repetition factor, or the number of frequency hops, or combination thereof.

Some benefits with using larger SCS for SRS are:
Faster UL beam management procedure in FR2. Increasing the SCS by X times, the SRS symbol duration decreases accordingly by X times. Then, setting the SRS repetition factor to X enables the gNB sweep X gNB beams, i.e. one per SRS OFDM symbol, instead of one gNB beam per PUSCH OFDM symbol. Alternatively, X SRS resources with usage ‘beamManagment’ can be configured in the duration of a PUSCH OFDM symbol enabling the UE to sound X UE beams instead of one. For example, by increasing the SCS from 120 kHz to 240 kHz, twice as many beams can be swept, either by gNB or UE, in the same time duration.
Faster antenna switching and decreased the gap duration. For example, for a 1T4R UE, when SCS is 15 kHz, it would take at least 7 OFDM symbols (4 single-symbol SRS resources and 3 single-symbol guard periods in between) to sound the 4 UE antennas. For Rel-15 UEs, this implies that the SRS resources need to be mapped to at least two slots, as SRS can only be mapped in the last 6 symbols of the slot. This creates channel aging problems, especially for DL heavy Time Division Duplex (TDD) structures with limited and non-consecutive UL slots. Even for Rel-16 UEs able to transmit SRS anywhere in the slot, it implies that half of the slot duration is allocated to SRS, which might be a prohibitive overhead. When for the same 1T4R UE the SRS SCS is increased to 60 kHz, the 4 UE antennas can be sounded within 2 OFDM symbols, as the SRS symbols and the guard periods have a quarter duration of the corresponding ones for 15 kHz. Even if the four SRS resources are configured with repetition 2 to recover half of the link budget loss, still only 3 OFDM symbols are needed to complete the antenna switching. In both aforementioned 60 kHz examples, the total duration of the guard periods is less than 1 OFDM symbol, as opposed to 3 whole symbols for 15 kHz. Expediting the antenna switching and decreasing the total gap duration is likely to become even more important in Rel-17, which currently has in scope sounding 6 or 8 UE antennas, even with a single TX chain.
Sounding a wider bandwidth for a given SRS sequence length. A wider BW per SRS occasion is good for achieving higher time-domain resolution, while spreading the SRS sequence over the BW is good for avoiding fading dips. For FDD reciprocity, SRS bandwidth determines the delay-domain resolution. For the 3D-UMi and 3D-UMa channels in 3GPP 36.873, the mean delay spread are 129 ns and 363 ns for Non-Line-of-Sight (NLoS) and 65 ns and 93 ns for Line-of-Sight (LoS), respectively. Hence, a large bandwidth (e.g., 40 MHz, 100 MHz) is required to resolve different delay taps. When a large bandwidth is used, a larger SCS can reduce the number of frequency samples while maintaining the delay-domain resolution. Also, the entire sounding BW can be reached with fewer frequency hops; this is important to reduce the effects of channel aging amongst the frequency hops.
Better interference averaging when sequence hopping is enabled, due to more dynamic, i.e. per sub-OFDM symbol, hopping of the Zadoff-Chu base sequences used for SRS across different cells.

Certain embodiments (or portions thereof) may be specified in a standard, such as 3GPP TS 38.211, 38.214, 38.331, and/or other suitable standard.

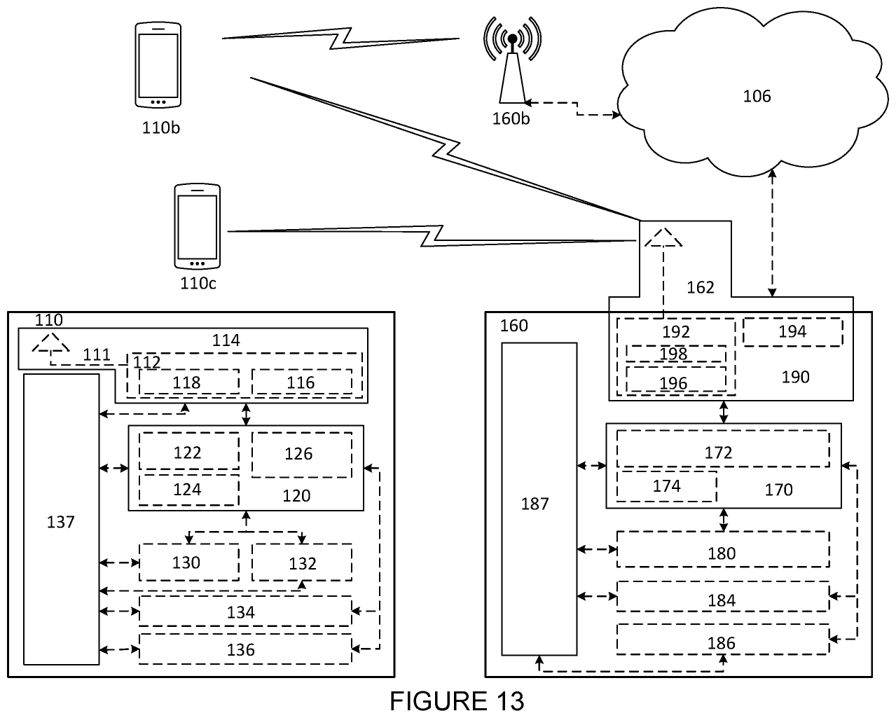

Although the subject matter described herein may be implemented in any appropriate type of system using any suitable components, the embodiments disclosed herein are described in relation to a wireless network, such as the example wireless network illustrated in FIG. 13. For simplicity, the wireless network of FIG. 13 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2nd, 3rd, 4th, or 5th generation (2G, 3G, 4G, or 5G, respectively) standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., Mobile Switching Center (MSCs), Mobility Management Entities (MMEs)), Operation and Maintenance (O&M) nodes, Operations Support System (OSS) nodes, Self-Optimized Network (SON) nodes, positioning nodes (e.g., Evolved-Serving Mobile Location Centres (E-SMLCs)), and/or Minimization of Drive Tests (MDTs). As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 13, network node 160 includes processing circuitry 170, device readable medium 180, interface 190, auxiliary equipment 184, power source 186, power circuitry 187, and antenna 162. Although network node 160 illustrated in the example wireless network of FIG. 13 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, Global System for Mobile communication (GSM), Wide Code Division Multiplexing Access (WCDMA), LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160, but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 13 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120, and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110 as a whole, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into WD 110, and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network, and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry. Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

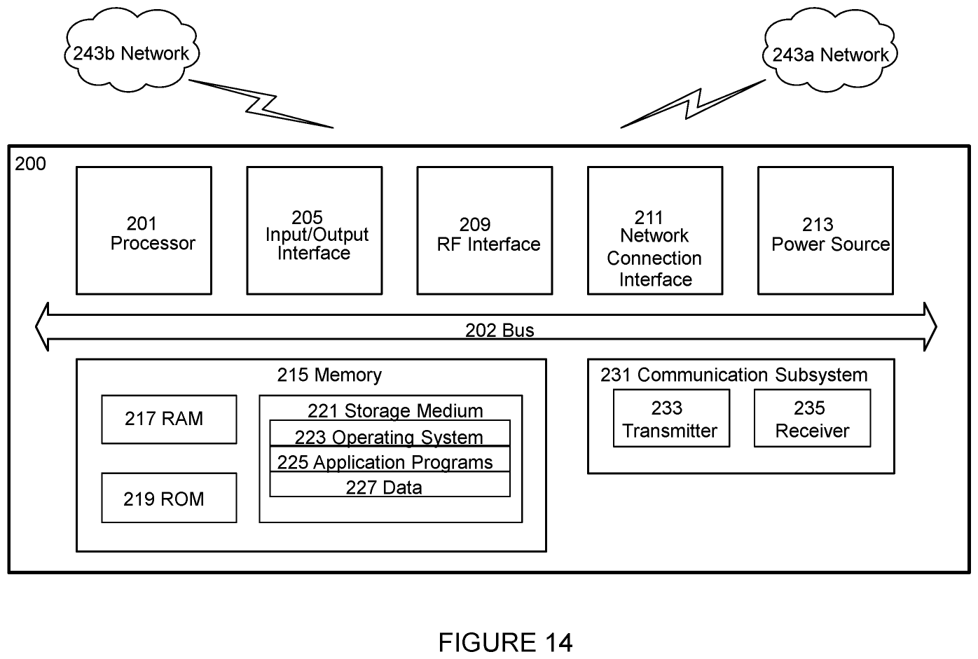

FIG. 14 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 2200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 14, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 14 is a UE, the components discussed herein are equally applicable to a WD, and vice-versa.

In FIG. 14, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may utilize all of the components shown in FIG. 14, or only a subset of the components. The level of integration between the components may vary from one UE to another UE. Further, certain UEs may contain multiple instances of a component, such as multiple processors, memories, transceivers, transmitters, receivers, etc.

In FIG. 14, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 14, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 14, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, Evolved Universal Terrestrial Radio Access Network (UTRAN), WiMax, or the like. Each transceiver may include transmitter 233 and/or receiver 235 to implement transmitter or receiver functionality, respectively, appropriate to the Radio Access Network (RAN) links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

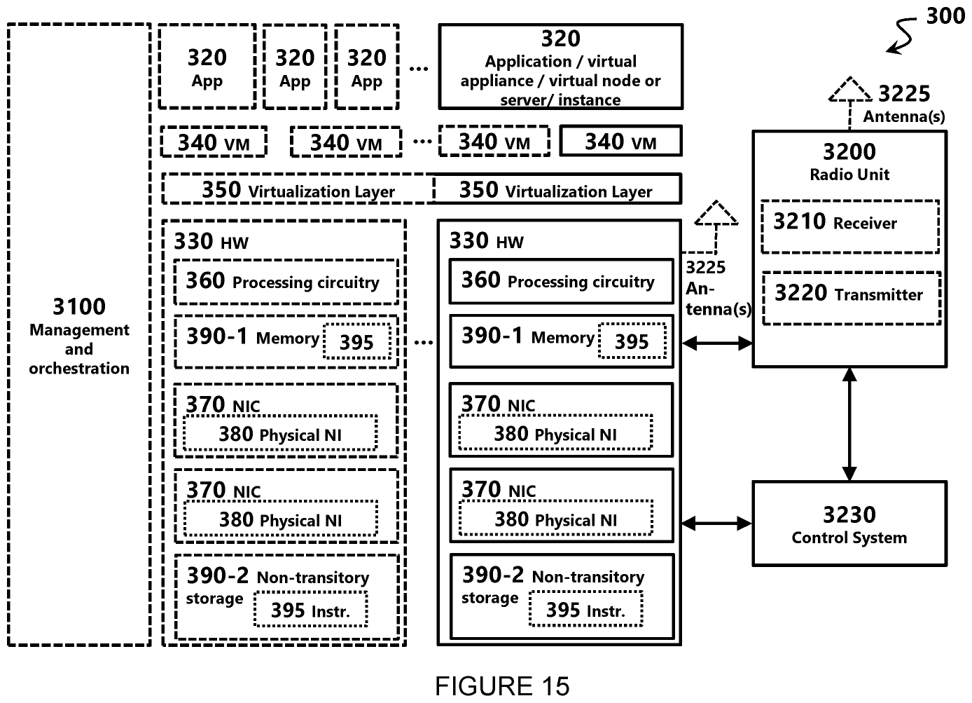

FIG. 15 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 15, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 15.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signalling can be effected with the use of control system 3230 which may alternatively be used for communication between the hardware nodes 330 and radio units 3200.

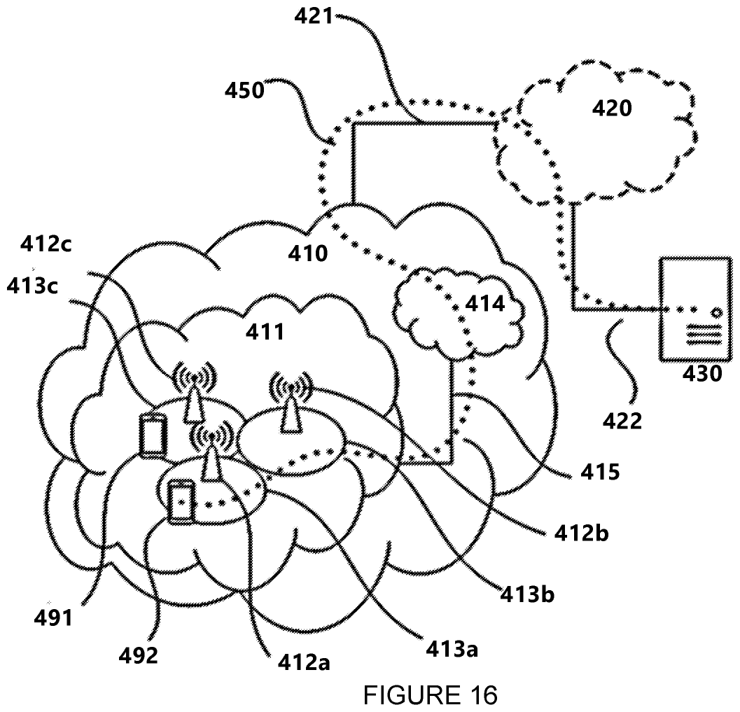

With reference to FIG. 16, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 16 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

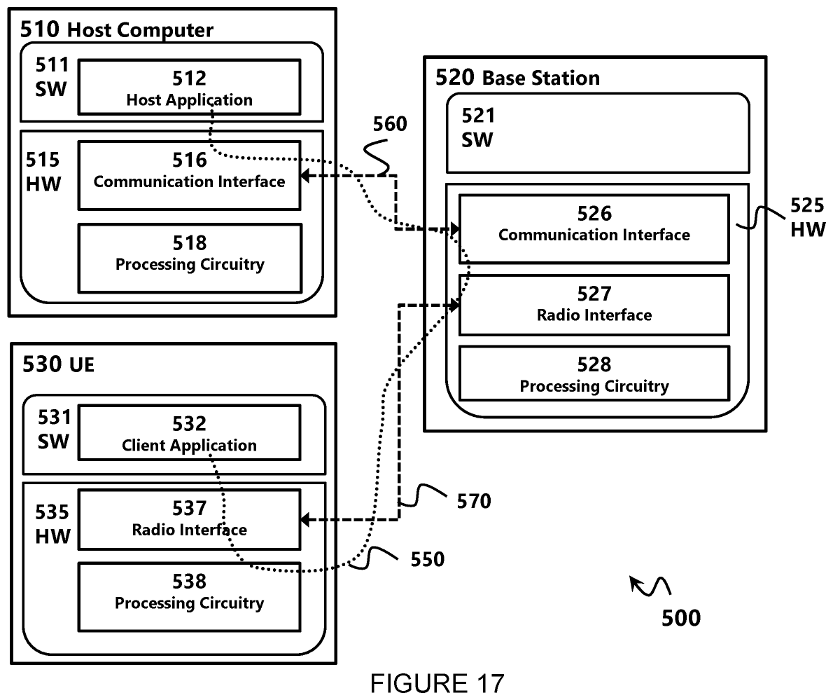

Example implementations, in accordance with an embodiment, of the UE, base station and host computer discussed in the preceding paragraphs will now be described with reference to FIG. 17. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 17) served by base station 520. Communication interface 526 may be configured to facilitate connection 560 to host computer 510. Connection 560 may be direct or it may pass through a core network (not shown in FIG. 17) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 17 may be similar or identical to host computer 430, one of base stations 412a, 412b, 412c and one of UEs 491, 492 of FIG. 16, respectively. This is to say, the inner workings of these entities may be as shown in FIG. 17 and independently, the surrounding network topology may be that of FIG. 16.

In FIG. 17, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the data rate or power consumption thereby provide benefits such as reduced user waiting time, better responsiveness, or extended battery lifetime.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

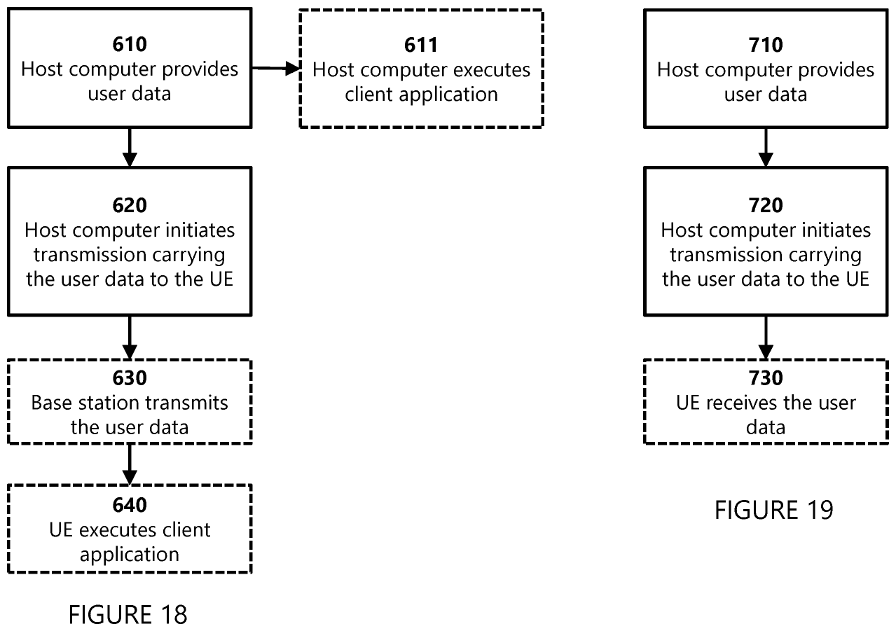

FIG. 18 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 18 will be included in this section. In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 19 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 19 will be included in this section. In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

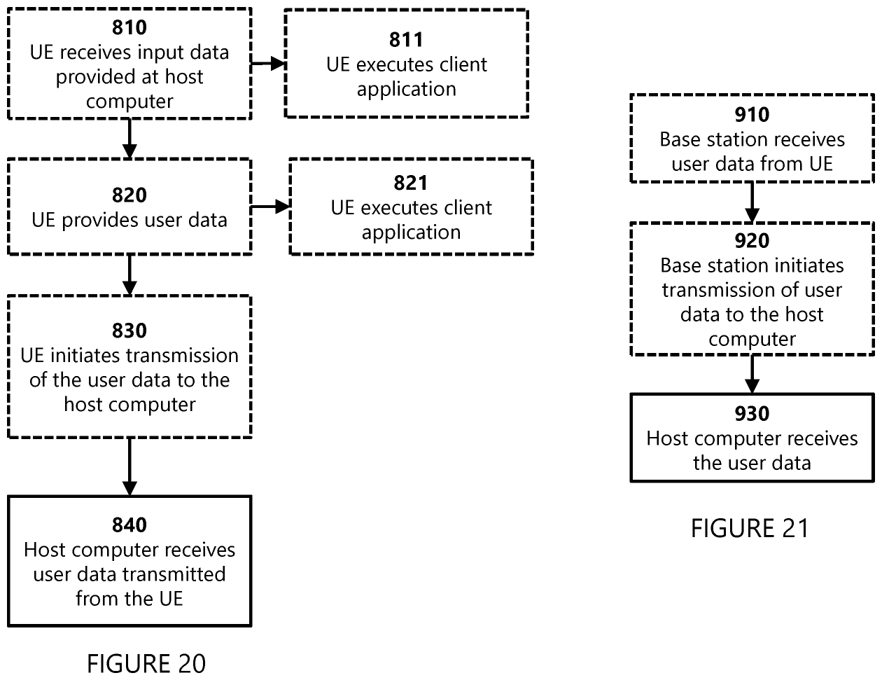

FIG. 20 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 20 will be included in this section. In step 810 (which may be optional), the UE receives input data provided by the host computer. Additionally or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 21 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 21 will be included in this section. In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

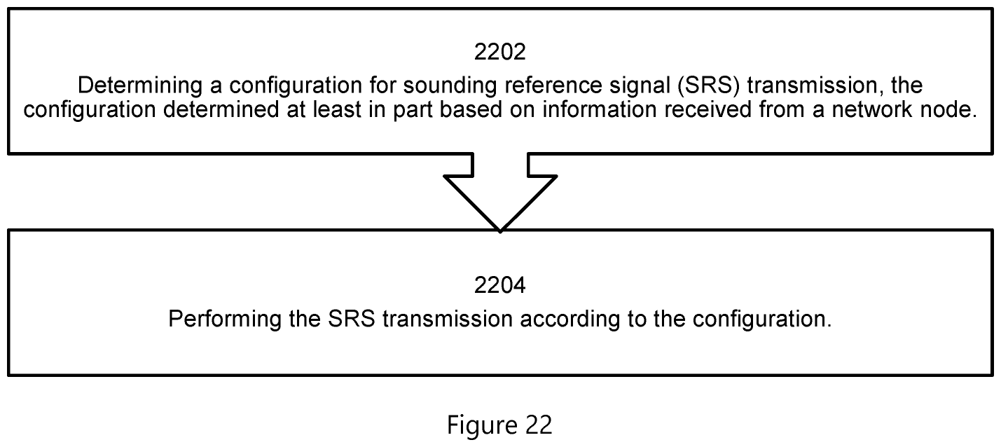

FIG. 22 depicts a method in accordance with particular embodiments. The method may be performed by a wireless device, such as wireless device 110 or UE 200. In certain embodiments, the wireless device comprises processing circuitry (e.g., processing circuitry 120 or 201) configured to execute a computer program that causes the wireless device to perform the method. The method begins at step 2202 with determining a configuration for SRS transmission. Certain embodiments determine the configuration at least in part based on information received from a network node. For example, certain embodiments receive the information used for determining the configuration for the SRS transmission from the network node via RRC signaling. The method and proceeds to step 2204 with performing the SRS transmission according to the configuration determined in step 2202. Examples of configurations for SRS transmission are described above. For example, see the discussion of “Embodiment 1: Non-contiguous regular/irregular frequency-domain PRB patterns,” “Embodiment 2: Varying transmission comb, comb offset, and cyclic shift,” and “Embodiment 3: Configured SRS subcarrier spacing.” Examples of configurations for SRS transmission are also described below.

In certain embodiments, the configuration for the SRS transmission comprises non-contiguous parts of a frequency-domain sounding bandwidth in a given OFDM symbol. See “Embodiment 1: Non-contiguous regular/irregular frequency-domain PRB patterns” for examples.

In certain embodiments, the configuration configures a transmission comb, a comb offset, and/or a cyclic shift differently in different PRBs spanning an SRS resource. See “Embodiment 2: Varying transmission comb, comb offset, and cyclic shift” for examples. SRS parameters can be varied over the configured PRBs. As one example, the configuration may configure cyclic shift 1 for an even period and cyclic shift 2 for an odd period.

In certain embodiments, each of a plurality of PRBs of an SRS resource belongs to the same OFDM symbol. Examples are shown in FIGS. 6, 7, 10, 11, and 12. In certain embodiments, at least one PRB of an SRS resource belongs to a different OFDM symbol than at least one other PRB of the SRS resource. Examples are shown in FIGS. 8 and 9. The PRBs of an SRS resource may be contiguous. Examples are shown in FIGS. 6 and 11. The PRBs of an SRS resource may be non-contiguous. Examples are shown in FIGS. 7, 8, 9, 10, and 12.

In certain embodiments, the configuration varies a comb configuration over sounded PRBs in an irregular pattern.

In certain embodiments, the configuration varies a comb configuration over sounded PRBs in different SRS resources.

In certain embodiments, the information received from the network node explicitly signals a set of PRBs that are occupied by a given SRS and which transmission comb to use in each PRB. As an example, the information received from the network node comprises a first bit map indicating the set of PRBs that are occupied by the given SRS and a second bit map indicating which transmission comb to use in each PRB. FIGS. 11 and 12 illustrate examples.

In certain embodiments, the information received from the network node indicates one out of multiple pre-determined PRB allocations and comb configurations.

In certain embodiments, the configuration configures an SCS used for the SRS transmission differently than an SCS used for a PUSCH. See “Embodiment 3: Configured SRS subcarrier spacing” for examples. As an example, the SCS used for the SRS transmission is higher than the SCS used for the PUSCH. In certain embodiments, the SCS used for the SRS transmission is configured with usage beamManagement.

In certain embodiments, the configuration configures a regular frequency-domain PRB pattern. In certain embodiments, the configuration configures an irregular frequency-domain PRB pattern.

For other examples, see the “Group A” embodiments.

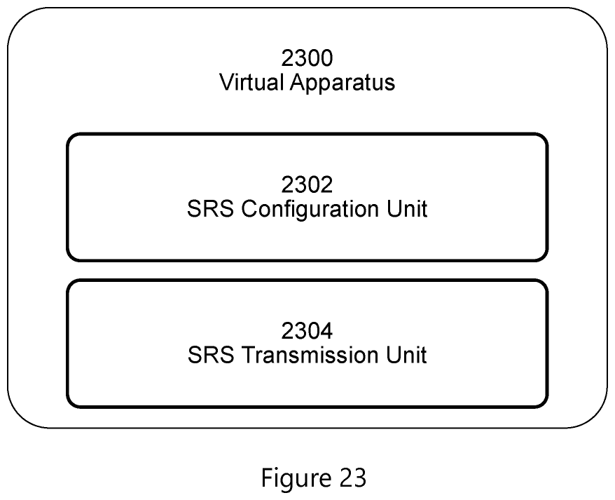

FIG. 23 illustrates a schematic block diagram of an apparatus 2300 in a wireless network (for example, the wireless network shown in FIG. 13). The apparatus may be implemented in a wireless device (e.g., wireless device 110 or network node 160 shown in FIG. 13). Apparatus 2300 is operable to carry out the example method described with reference to FIG. 22 and possibly any other processes or methods disclosed herein. It is also to be understood that the method of FIG. 22 is not necessarily carried out solely by apparatus 2300. At least some operations of the method can be performed by one or more other entities.

Virtual Apparatus 2300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause SRS configuration unit 2302, SRS transmission unit 2304, and any other suitable units of apparatus 2300 to perform corresponding functions according one or more embodiments of the present disclosure.

As illustrated in FIG. 23, apparatus 2300 includes SRS configuration unit 2302 and SRS transmission unit 2304. SRS configuration unit 2302 is configured to determine a configuration for SRS transmission and apply the configuration to SRS transmission unit 2304. Examples of configurations for SRS transmission are described above. For example, see the discussion of “Embodiment 1: Non-contiguous regular/irregular frequency-domain PRB patterns,” “Embodiment 2: Varying transmission comb, comb offset, and cyclic shift,” and “Embodiment 3: Configured SRS subcarrier spacing.” Examples of configurations for SRS transmission are also described below. For example, see the “Group A” embodiments. SRS transmission unit 2304 is configured to perform SRS transmission according to the configuration determined by SRS configuration unit 2302.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

In some embodiments a computer program, computer program product or computer readable storage medium comprises instructions which when executed on a computer perform any of the embodiments disclosed herein. In further examples the instructions are carried on a signal or carrier and which are executable on a computer wherein when executed perform any of the embodiments disclosed herein.

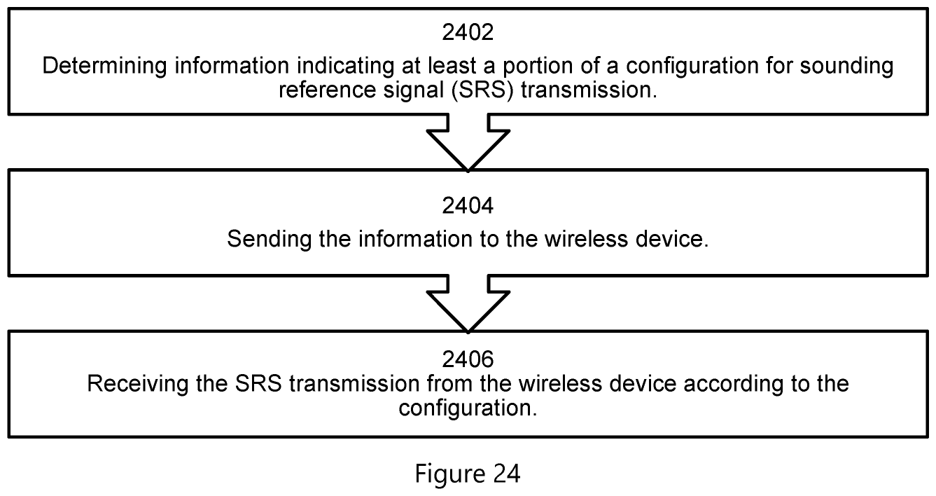

In certain embodiments, a network node (such as network node 160) performs methods analogous to those described as being performed by a wireless device. As an example, network node 160 may perform functionality reciprocal to that of wireless device 110 in order to support the embodiments disclosed herein. Thus, for an embodiment in which a wireless device sends a signal to a network node, a reciprocal embodiment may comprise the network node receiving the signal from the wireless device. Similarly, for an embodiment in which the wireless device receives a signal from the network node, a reciprocal embodiment may comprise the network node sending the signal to the wireless device. In certain embodiments, the network node comprises processing circuitry (e.g., processing circuitry 170) configured to execute a computer program that causes the network node to perform the method. As an example, FIG. 24 illustrates a method implemented in a network node in accordance with certain embodiments.

The method of FIG. 24 begins at step 2402 with determining information indicating at least a portion of a configuration for SRS transmission. Examples of the configuration for the SRS transmission are further described above, for example, with respect to FIG. 22. In certain embodiments, the configuration for the SRS transmission comprises non-contiguous parts of a frequency-domain sounding bandwidth in a given OFDM symbol. In certain embodiments, the configuration configures a transmission comb, a comb offset, and/or a cyclic shift differently in different PRBs spanning an SRS resource.

In certain embodiments, each of a plurality of PRBs of an SRS resource belongs to the same OFDM symbol. In certain embodiments, at least one PRB of an SRS resource belongs to a different OFDM symbol than at least one other PRB of the SRS resource.

In certain embodiments, the configuration varies a comb configuration over sounded PRBs in an irregular pattern.

In certain embodiments, the configuration varies a comb configuration over sounded PRBs in different SRS resources.

In certain embodiments, the configuration configures an SCS used for the SRS transmission differently than an SCS used for a PUSCH. As an example, the SCS used for the SRS transmission is higher than the SCS used for the PUSCH. In certain embodiments, the SCS used for the SRS transmission is configured with usage beamManagement

In certain embodiments, the configuration configures a regular frequency-domain PRB pattern.

In certain embodiments, the configuration configures an irregular frequency-domain PRB pattern.

The method of FIG. 24 proceeds to step 2404 with sending the information to the wireless device. Certain embodiments send the information via RRC signaling. In certain embodiments, the information sent to the wireless device explicitly signals a set of PRBs that are occupied by a given SRS and which transmission comb to use in each PRB. As an example, the information sent to the wireless device comprise a first bit map indicating the set of PRBs that are occupied by the given SRS and a second bit map indicating which transmission comb to use in each PRB.

In certain embodiments, the information sent to the wireless device indicates one out of multiple pre-determined PRB allocations and comb configurations. As an example, certain embodiments select the one out of the multiple pre-determined PRB allocations and comb configurations. In certain embodiments, the selection is based on intermodulation properties associated with the pre-determined PRB allocations and comb configurations. In certain embodiments, the selection is based on time-delay estimation properties associated with the pre-determined PRB allocations and comb configurations.

In certain embodiments, the method of FIG. 24 further comprises receiving the SRS transmission from the wireless device according to the configuration, as shown in step 2606. The network node may use the SRS transmission to determine information about a radio condition (such as an effect of multipath fading, scattering, Doppler, or power loss on a transmitted signal), for example, in order to estimate channel quality. The information may be used to make decisions for uplink resource allocation, resource scheduling, beam management, power control, link adaptation, decoding data transmitted from the wireless device, or for other suitable operation of the network node.

### EMBODIMENTS

### Group A Embodiments

1. A method performed by a wireless device, the method comprising:
   determining a configuration for sounding reference signal (SRS) transmission; and
   performing the SRS transmission according to the configuration.
2. The method of embodiment 1, wherein the configuration uses non-contiguous parts of a bandwidth for the SRS transmission.
3. The method of any of embodiments 1-2, wherein the configuration configures a regular frequency-domain physical resource block (PRB) pattern.
4. The method of any of embodiments 1-2, wherein the configuration configures an irregular frequency-domain PRB pattern.
5. The method of any of embodiments 1-4, wherein the configuration configures a transmission comb differently in different PRBs spanning an SRS resource.
6. The method of any of embodiments 1-5, wherein the configuration configures a comb offset differently in different PRBs spanning an SRS resource.
7. The method of any of embodiments 1-6, wherein the configuration configures a cyclic shift differently in different PRBs spanning an SRS resource.
8. The method of any of embodiments 1-7, wherein the configuration configures a subcarrier spacing (SCS) used for the SRS transmission differently than an SCS used for a physical uplink shared channel (PUSCH).
9. The method of embodiment 8, wherein the SCS used for the SRS transmission is higher than the SCS used for the PUSCH.
10. The method of any of embodiments 1-8, wherein the configuration is determined at least in part based on information received from a network node.
11. The method of embodiment 10, wherein the information is received from the network node via radio resource control (RRC) signaling.
12. The method of any of the previous embodiments, further comprising:
   providing user data; and
   forwarding the user data to a host computer via the transmission to the base station.

### Group B Embodiments

13. A method performed by a base station, the method comprising:
   determining a configuration for receiving a sounding reference signal (SRS) transmission from a wireless device; and
   receiving the SRS transmission according to the configuration.
14. The method of embodiment 13, wherein the configuration uses non-contiguous parts of a bandwidth for the SRS transmission.
15. The method of any of embodiments 13-14, wherein the configuration configures a regular frequency-domain physical resource block (PRB) pattern.
16. The method of any of embodiments 13-14, wherein the configuration configures an irregular frequency-domain PRB pattern.
17. The method of any of embodiments 13-16, wherein the configuration configures a transmission comb differently in different PRBs spanning an SRS resource.
18. The method of any of embodiments 13-17, wherein the configuration configures a comb offset differently in different PRBs spanning an SRS resource.
19. The method of any of embodiments 13-18, wherein the configuration configures a cyclic shift differently in different PRBs spanning an SRS resource.
20. The method of any of embodiments 13-19, wherein the configuration configures a subcarrier spacing (SCS) used for the SRS transmission differently than an SCS used for a physical uplink shared channel (PUSCH).
21. The method of embodiment 20, wherein the SCS used for the SRS transmission is higher than the SCS used for the PUSCH.
22. The method of any of embodiments 13-21, further comprising sending the wireless device information from which the wireless determines at least a portion of the configuration.
23. The method of embodiment 22, wherein the information is sent via radio resource control (RRC) signaling.
24. The method of any of the previous embodiments, further comprising:
   obtaining user data; and
   forwarding the user data to a host computer or a wireless device.

### Group C Embodiments

25. A wireless device, the wireless device comprising:
   processing circuitry configured to perform any of the steps of any of the Group A embodiments; and
   power supply circuitry configured to supply power to the wireless device.
26. A base station, the base station comprising:
   processing circuitry configured to perform any of the steps of any of the Group B embodiments;
   power supply circuitry configured to supply power to the base station.
27. A user equipment (UE), the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.
28. A computer program, the computer program comprising instructions which when executed on a computer perform any of the steps of any of the Group A embodiments.
29. A computer program product comprising a computer program, the computer program comprising instructions which when executed on a computer perform any of the steps of any of the Group A embodiments.
30. A non-transitory computer-readable storage medium or carrier comprising a computer program, the computer program comprising instructions which when executed on a computer perform any of the steps of any of the Group A embodiments.
31. A computer program, the computer program comprising instructions which when executed on a computer perform any of the steps of any of the Group B embodiments.
32. A computer program product comprising a computer program, the computer program comprising instructions which when executed on a computer perform any of the steps of any of the Group B embodiments.
33. A non-transitory computer-readable storage medium or carrier comprising a computer program, the computer program comprising instructions which when executed on a computer perform any of the steps of any of the Group B embodiments.
34. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
35. The communication system of the pervious embodiment further including the base station.
36. The communication system of the previous 2 embodiments, further including the UE, wherein the UE is configured to communicate with the base station.
37. The communication system of the previous 3 embodiments, wherein:
   the processing circuitry of the host computer is configured to execute a host application, thereby providing the user data; and
   the UE comprises processing circuitry configured to execute a client application associated with the host application.
38. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
39. The method of the previous embodiment, further comprising, at the base station, transmitting the user data.
40. The method of the previous 2 embodiments, wherein the user data is provided at the host computer by executing a host application, the method further comprising, at the UE, executing a client application associated with the host application.
41. A user equipment (UE) configured to communicate with a base station, the UE comprising a radio interface and processing circuitry configured to performs the of the previous 3 embodiments.
42. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
43. The communication system of the previous embodiment, wherein the cellular network further includes a base station configured to communicate with the UE.
44. The communication system of the previous 2 embodiments, wherein:
   the processing circuitry of the host computer is configured to execute a host application, thereby providing the user data; and
   the UE's processing circuitry is configured to execute a client application associated with the host application.
45. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
46. The method of the previous embodiment, further comprising at the UE, receiving the user data from the base station.
47. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
48. The communication system of the previous embodiment, further including the UE.
49. The communication system of the previous 2 embodiments, further including the base station, wherein the base station comprises a radio interface configured to communicate with the UE and a communication interface configured to forward to the host computer the user data carried by a transmission from the UE to the base station.
50. The communication system of the previous 3 embodiments, wherein:
   the processing circuitry of the host computer is configured to execute a host application; and
   the UE's processing circuitry is configured to execute a client application associated with the host application, thereby providing the user data.
51. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
52. A method implemented in a communication system including a host computer, a base station and a user equipment (UE), the method comprising:
   at the host computer, receiving user data transmitted to the base station from the UE, wherein the UE performs any of the steps of any of the Group A embodiments.
53. The method of the previous embodiment, further comprising, at the UE, providing the user data to the base station.
54. The method of the previous 2 embodiments, further comprising:
   at the UE, executing a client application, thereby providing the user data to be transmitted; and
   at the host computer, executing a host application associated with the client application.
55. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
56. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
57. The communication system of the previous embodiment further including the base station.
58. The communication system of the previous 2 embodiments, further including the UE, wherein the UE is configured to communicate with the base station.
59. The communication system of the previous 3 embodiments, wherein:
   the processing circuitry of the host computer is configured to execute a host application;
   the UE is configured to execute a client application associated with the host application, thereby providing the user data to be received by the host computer.
60. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
61. The method of the previous embodiment, further comprising at the base station, receiving the user data from the UE.
62. The method of the previous 2 embodiments, further comprising at the base station, initiating a transmission of the received user data to the host computer.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set. As used in this document, “based on” means “based at least in part on” unless a different meaning is clearly given and/or is implied from the context in which it is used.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the following claims.

1. A method performed by a wireless device, the method comprising:
determining a configuration for sounding reference signal (SRS) transmission, the configuration determined at least in part based on information received from a network node; and
performing the SRS transmission according to the configuration.

2.-18. (canceled)

19. A method performed by a network node, the method comprising:
determining information indicating at least a portion of a configuration for sounding reference signal (SRS) transmission; and
sending the information to the wireless device.

20.-39. (canceled)

40. A wireless device, the wireless comprising:
power supply circuitry configured to supply power to the wireless device; and
processing circuitry configured to:
determine a configuration for sounding reference signal (SRS) transmission, the configuration determined at least in part based on information received from a network node; and
perform the SRS transmission according to the configuration.

41. The wireless device of claim 40, wherein the configuration for the SRS transmission comprises non-contiguous parts of a frequency-domain sounding bandwidth in a given orthogonal frequency-division multiplexing (OFDM) symbol.

42. The wireless device of claim 40, wherein the configuration configures a transmission comb differently in different physical resource blocks (PRBs) spanning an SRS resource.

43. The wireless device of claim 40, wherein the configuration configures a comb offset differently in different PRBs spanning an SRS resource.

44. The wireless device of claim 40, wherein the configuration configures a cyclic shift differently in different PRBs spanning an SRS resource.

45. The wireless device of claim 40, wherein each of a plurality of PRBs of an SRS resource belongs to the same OFDM symbol.

46. The wireless device of claim 40, wherein at least one PRB of an SRS resource belongs to a different OFDM symbol than at least one other PRB of the SRS resource.

47. The wireless device of claim 40, wherein the configuration varies a comb configuration over sounded PRBs in an irregular pattern.

48. The wireless device of claim 40, wherein the configuration varies a comb configuration over sounded PRBs in different SRS resources.

49. The wireless device of claim 40, wherein the information received from the network node explicitly signals a set of PRBs that are occupied by a given SRS and which transmission comb to use in each PRB.

50. The wireless device of claim 49, wherein the information received from the network node comprise a first bit map indicating the set of PRBs that are occupied by the given SRS and a second bit map indicating which transmission comb to use in each PRB.

51. The wireless device of claim 40, wherein the information received from the network node indicates one out of multiple pre-determined PRB allocations and comb configurations.

52. The wireless device of claim 40, wherein the configuration configures a subcarrier spacing (SCS) used for the SRS transmission differently than an SCS used for a physical uplink shared channel (PUSCH).

53. The wireless device of claim 52, wherein the SCS used for the SRS transmission is higher than the SCS used for the PUSCH.

54. The wireless device of claim 52, wherein the SCS used for the SRS transmission is configured with usage beamManagement.

55. The wireless device of claim 40, wherein the configuration configures a regular frequency-domain PRB pattern.

56. The wireless device of claim 40, wherein the configuration configures an irregular frequency-domain PRB pattern.

57. The wireless device of claim 40, wherein the processing circuitry is further configured to:
receive the information used for determining the configuration for the SRS transmission from the network node via radio resource control (RRC) signaling.

58. A network node, the network node comprising:
power supply circuitry configured to supply power to the network node; and
processing circuitry configured to:
determine information indicating at least a portion of a configuration for sounding reference signal (SRS) transmission; and
send the information to the wireless device.

59. The network node of claim 58, wherein the configuration for the SRS transmission comprises non-contiguous parts of a frequency-domain sounding bandwidth in a given OFDM symbol.

60. The network node of claim 58, wherein the configuration configures a transmission comb differently in different physical resource blocks (PRBs) spanning an SRS resource.

61. The network node of claim 58, wherein the configuration configures a comb offset differently in different PRBs spanning an SRS resource.

62. The network node of claim 58, wherein the configuration configures a cyclic shift differently in different PRBs spanning an SRS resource.

63. The network node of claim 58, wherein each of a plurality of PRBs of an SRS resource belongs to the same OFDM symbol.

64.-78. (canceled)
